(19) United States
(12) Patent Application Publication
(10) Pub. No.: US 2010/0259516 A1
(43) Pub. Date: Oct. 14, 2010

(54) IMAGE DISPLAY APPARATUS COMPRISING DRIVING CHIP WITH VARIABLE LENGTH INTERNAL CONNECTION LINES

(75) Inventors: Su hyun PARK, Hwaseong-si (KR); Sang ho PARK, Seongnam-si (KR)

Correspondence Address: VOLENTINE & WHITT PLLC, ONE FREEDOM SQUARE, 11951 FREEDOM DRIVE SUITE 1260, RESTON, VA, 20190, US

(73) Assignee: SAMSUNG ELECTRONICS CO., LTD., Suwon-si (KR)

(21) Appl. No.: 12/753,994

(22) Filed: Apr. 5, 2010

(30) Foreign Application Priority Data
Apr. 10, 2009 (KR) 10-2009-0031367

(51) Int. Cl. G09G 5/00

(52) U.S. Cl. 345/204

(57) ABSTRACT

A display panel receives a driving signal from one or more driving chips to display an image. Each of the driving chips comprises a driver generating the driving signal, a plurality of output terminals outputting the driving signal supplied from the driver, and a plurality of internal connection lines electrically connecting the driver to the output terminals. The internal connection lines have lengths different from each other according to their positions in the driving chips.

### CROSS-REFERENCE TO RELATED APPLICATIONS

This application claims priority under 35 U.S.C. §119 to Korean Patent Application No. 10-2009-0031367 filed on Apr. 10, 2009, the disclosure of which is hereby incorporated by reference in its entirety.

### BACKGROUND

Embodiments of the inventive concept relate generally to an image display apparatus. More particularly, embodiments of the inventive concept relate to an image display apparatus having improved image quality.

Image display devices, such as liquid crystal displays, have become increasingly common in recent years. Such displays can now be found in numerous forms of electronic devices, ranging from portable telephones and cameras, to large screen televisions, and so on.

A liquid crystal display panel typically comprises a lower substrate, an upper substrate, and a liquid crystal layer disposed between the lower substrate and the upper substrate. A plurality of gate lines and data lines are arranged in a display area, with the gate lines arranged perpendicular to the data lines.

A peripheral area of the liquid crystal display panel typically contains a gate driving chip outputting gate signals to the gate lines or a data driving chip outputting data signals to the data lines. Additionally, the peripheral area typically comprises a plurality of gate-side connection lines electrically connecting the gate driving chip to the gate lines and a plurality of data-side connection lines electrically connecting the date driving chip to the data lines.

The length of each of the data-side connection lines generally becomes longer as it moves away from a center of the data driving chip. Where each of these connection lines becomes longer, line resistance increases accordingly. For instance, a resistance difference between a connection line disposed at the center of the data driving chip and the connection disposed at an outermost side may be significant. The resistance difference may cause signal delay variation to generate spots in the display area, thus deteriorating image quality of the liquid crystal display device.

### SUMMARY

Embodiments of the inventive concept provide an image display apparatus for improving image quality.

According to one embodiment of the inventive concept, an image display apparatus comprises a display panel comprising a plurality of signal lines receiving a driving signal and displaying an image in response to the driving signal, a driving chip comprising a data driver generating the driving signal, a plurality of output terminals outputting the driving signal supplied from the driver, and a plurality of internal connection lines electrically connecting the driver to the output terminals, and a plurality of external connection lines electrically connecting the output terminals to the signal lines. The internal connection lines are divided into two or more groups according to length of the internal connection lines, and the two or more groups are formed of materials of different resistivity.

In certain embodiments, the internal connection lines are divided into a first group connected to output terminals disposed at a central portion of the driving chip and second and third groups disposed on opposite distal portions of the driving chip, and the first group is formed of a first material, and the second and third groups are formed of a second material having a resistance less than that of the first material.

In certain embodiments, the first material comprises a polysilicon material, and the second material comprises a metal material. In certain embodiments, the driving chip further comprises active devices connected to the internal connection lines of the first group. In certain embodiments, the internal connection lines of the first group have widths that gradually increase from a central portion of the driving chip toward the distal portions of the driving chip, and the internal connection lines of the second and third groups have widths that gradually increase toward outermost internal connection lines on the distal portions.

In certain embodiments, a back surface of the driving chip has a rectangular shape having four outer edges, the output terminals are disposed along at least three of the four outer edges, and a plurality of input terminals receiving signals from the outside is disposed along the remaining outer edge. In certain embodiments, the output terminals are partially disposed on the remaining outer edge.

In certain embodiments, the image display apparatus further comprises a film on which the driving chip is mounted.

In certain embodiments, the external connection lines comprise a plurality of first external connection lines disposed on the display panel and connected to the signal lines, and a second external connection line disposed on the film to connect the output terminals of the driving chip to the first external connection lines of the display panel.

In certain embodiments, the output terminals are divided into a first group disposed on a central portion of the driving chip and second and third groups respectively disposed on opposite side edges of the driving chip, and the first external connection lines connected to the first group have curved shapes, and the first external connection lines connected to the second and third groups have oblique shapes. In certain embodiments, the driving chip is mounted on the display panel. In certain embodiments, the external connection lines are disposed on the display panel to electrically connect the output terminals of the driving chip to the signal lines.

In certain embodiments, the output terminals are divided into a first group disposed on a central portion of the driving chip and second and third groups respectively disposed on both side edges of the driving chip, and the external connection lines connected to the first group have curved shapes, and the external connection lines connected to the second and third groups have oblique shapes.

### BRIEF DESCRIPTION OF THE DRAWINGS

Embodiments of the inventive concept will be more clearly understood from the following detailed description taken in conjunction with the accompanying drawings. In the drawings, like reference numerals denote like features.

FIG. 1 is a plan view of a liquid crystal display device according to an embodiment of the inventive concept.

FIG. 2 is an enlarged view illustrating a portion “I” of FIG. 1.

FIG. 3 is a bottom view illustrating a driving chip of FIG. 2.

FIG. 4 is a block diagram of a data driver according to an embodiment of the inventive concept.

FIG. 5 is an enlarged view of a liquid crystal display panel according to another embodiment of the inventive concept.

FIG. 6 is a plan view of a liquid crystal display device according to another embodiment of the inventive concept.

### DETAILED DESCRIPTION OF THE EMBODIMENTS

Various embodiments of the inventive concept will be described more fully hereinafter with reference to the accompanying drawings. The inventive concept may, however, be embodied in many different forms and should not be construed as being limited to only the illustrated embodiments. Rather, these embodiments are presented as teaching examples.

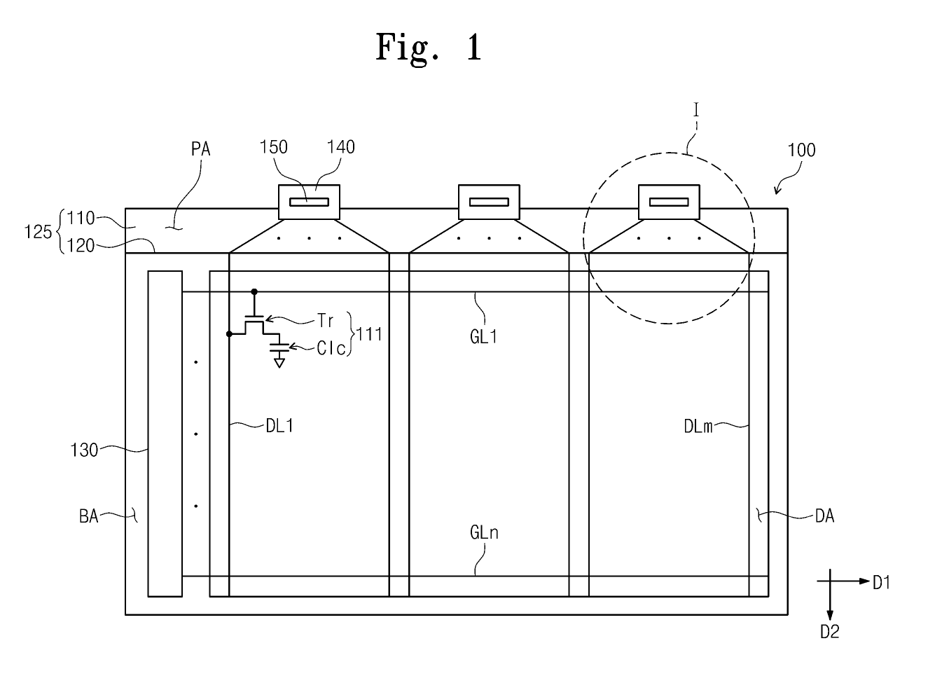

FIG. 1 is a plan view of a liquid crystal display device 100 according to an embodiment of the inventive concept.

Referring to FIG. 1, liquid crystal display device 100 comprises a liquid crystal display panel 125. Liquid crystal display panel 125 comprises a lower substrate 110, an upper substrate 120 facing lower substrate 110, and a liquid crystal layer (not shown) interposed between lower substrate 110 and upper substrate 120.

Upper substrate 120 has a smaller area than lower substrate 110, and therefore a portion of lower substrate 110 does not face upper substrate 120, but is exposed to the outside. The area where upper substrate 120 faces lower substrate 110 comprises a display area DA for displaying images and a black matrix area BA.

Display area DA represents an area in which a plurality of pixels 111 are disposed to display images. Black matrix area BA represents an area in which a black matrix is disposed to prevent light from being leaked at the periphery of display area DA.

First through n-th gate lines GL1 through GLn and first through m-th data lines DL1 through DLm are disposed in display area DA. First through n-th gate lines GL1 through GLn extend in a first direction D1, and first through m-th data lines DL1 through DLm extend in a second direction D2 perpendicular to first direction D1 so that they cross gate lines GL1 through GLn. Pixel areas are defined in display area DA. The pixel areas are arranged in a matrix defined by gate lines GL1 through GLn and data lines DL1 through DLm. Each of pixels 111 comprises a thin film transistor (TFT) Tr and a liquid crystal capacitor Clc and is disposed in each of the pixel areas.

A gate driver 130 located within black matrix area BA supplies gate signals to gate lines GL1 through GLn. Gate driver 130 is formed in black matrix area BA by a thin film process used to form pixels 111 in display area DA.

An exposed area of lower substrate 110 is defined as a peripheral area PA. A plurality of tape carrier packages (TCPs) 140 is attached to peripheral area PA, and a driving chip 150 is mounted on each of TCPs 140. A data driver (not shown) for outputting data signals is built in driving chip 150. A plurality of first external connection lines and a plurality of second external connection lines are respectively disposed in liquid crystal display panel 125 and corresponding TCPs 140 to supply the data signals output from output terminals of driving chip 150 to data lines DL1 through DLm disposed on liquid crystal display panel 125.

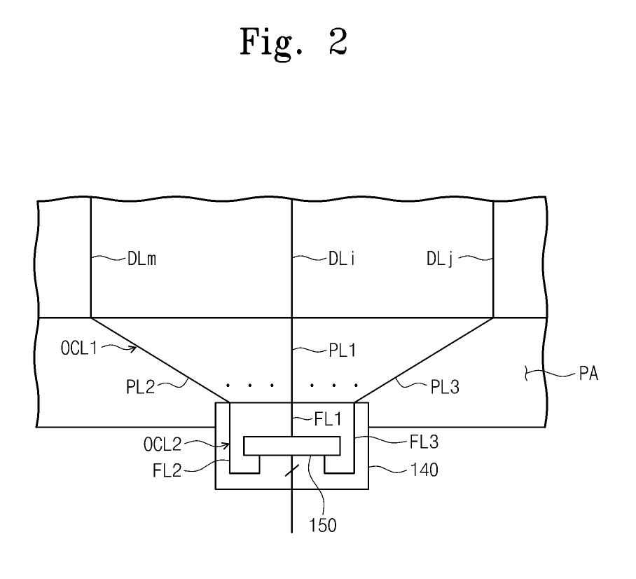

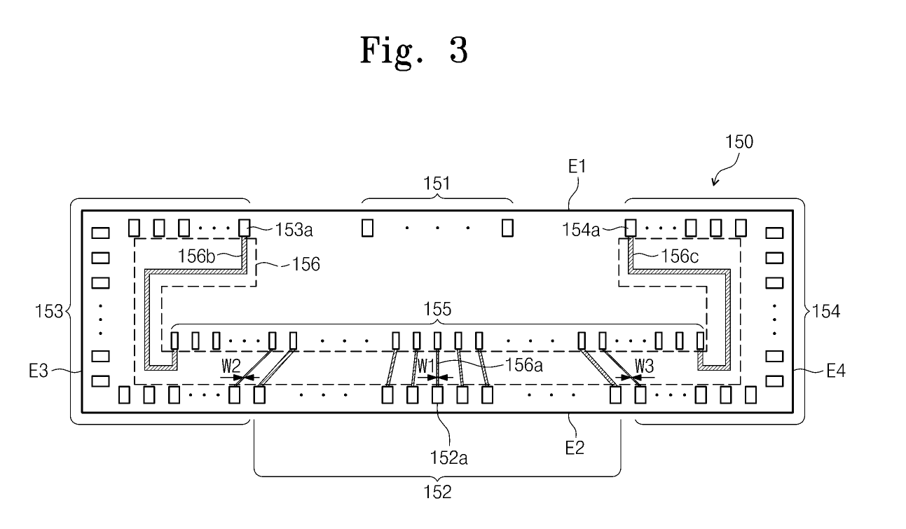

FIG. 2 is an enlarged view illustrating a portion “I” of FIG. 1, and FIG. 3 is a bottom view illustrating a driving chip of FIG. 2. Although a structure in which one driving chip is connected to data lines disposed on the liquid crystal display panel is illustrated in FIGS. 2 and 3, other driving chips have the same structure described above. Accordingly, duplicated descriptions are omitted for conciseness.

Referring to FIG. 2, a plurality of first external connection lines OCL1 is disposed in peripheral area PA of liquid crystal display panel 125, and a plurality of second external connection lines OCL2 is disposed in the corresponding one of TCPs 140. First external connection lines OCL1 and second external connection lines OCL2 are electrically connected to each other by an anisotropic conductive film (not shown), a conductive adhesive.

Referring to FIG. 3, driving chip 150 comprises a plurality of input terminals 151 and a plurality of output terminals 152, 153, and 154. The data driver (not shown) is built in driving chip 150. Driving chip 150 receives various signals supplied from external sources through input terminals 151 to supply the received signals to the data driver. Output terminals 152, 153, and 154 receive data signals generated from the data driver to supply the received data signals to data lines DL1 through DLm through first and second external connection lines OCL1 and OCL2.

A back surface of driving chip 150 has a rectangular shape formed by first and second long edges E1 and E2 and first and second short edges E3 and E4. Input terminals 151 are disposed along first long edge E1 of the back surface, and output terminals 152, 153, and 154 are disposed along second long edge E2 and first and second short edges E3 and E4. For example, when the number of output terminals 152, 153, and 154 increases, a portion of output terminals 152, 153, and 154 are partially disposed along first long edge E1.

Referring to FIGS. 2 and 3, second external connection lines OCL2 comprise a first film line FL1 connected to a first output terminal 152a positioned at the exact center of driving chip 150, with second and third film lines FL2 and FL3 respectively connected to second and third output terminals 153a and 154a positioned on opposite sides, or distal portions, of driving chip 150.

First film line FL1 has the shortest length among second external connection lines OCL2, and second and third film lines FL2 and FL3 have the longer lengths among second external connection lines OCL2. That is, second external connection lines OCL2 gradually increase in length from first film line FL1 toward second and third film lines FL2 and FL3. As a result, resistance within second external connection lines OCL2 gradually increases from first film line FL1 toward second and third film lines FL2 and FL3. The difference in resistance between second and third film lines FL2 and FL3 and first film line FL1 is measured at several ohms.

Further, first external connection lines OCL1 comprise a first panel line PL1 connected to first film line FL1 and second and third panel lines PL2 and PL3 respectively connected to second and third film lines FL2 and FL3. First panel line PL1 has the shortest length among first external connection lines OCL1, and second and third panel lines PL2 and PL3 have the longer lengths among first external connection lines OCL1. That is, first external connection lines OCL1 gradually increases in length from first panel line PL1 toward second and third panel lines PL2 and PL3. As a result, resistance in first external connection lines OCL1 gradually increases from first panel line PL1 toward second and third panel lines PL2 and PL3. The difference in resistance between second and third panel lines PL2 and PL3 and first panel line PL1 is measured at several hundred ohms.

The total resistance between first output terminal 152a of driving chip 150 and an i-th data line DLi corresponding to first output terminal 152a is defined as a first resistance. The total resistance between second output terminal 153a of driving chip 150 and an m-th data line DLm corresponding to second output terminal 153a is defined as a second resistance. The total resistance between third output terminal 154a of driving chip 150 and a j-th data line DLj corresponding to third output terminal 154a is defined as a third resistance. In this case, a resistance of more than several hundred ohms occurs between the first resistance and the second resistance. Also, a resistance difference of more than several hundred ohms occurs between the first resistance and the third resistance.

Driving chip 150 further comprises a plurality of internal output terminals 155 connected to the data driver and a plurality of internal connection lines 156 connecting internal output terminals 155 to output terminals 152, 153, and 154 of driving chip 150.

Internal output terminals 155 represent terminals connected to an output buffer (not shown) used during a last stage of the data driver to output data signals. The number of internal output terminals 155 corresponds to that of output terminals 152, 153, and 154. Each of internal output terminals 155 is electrically connected to a corresponding output terminal through a corresponding internal connection line.

Internal output terminals 155 are disposed adjacent to long edge E2. However, some of output terminals 152, 153, and 154 are disposed adjacent to first long edge E1 and first and second short edges E3 and E4. In order for internal output terminals 155 to reach the portions of output terminals 152, 153, and 154 that are not immediately adjacent, internal connection lines 156 gradually increase in length from a first internal connection line 156a connected to first output terminal 152a disposed at the exact center of driving chip 150 toward second and third internal connection lines 156b and 156c respectively connected to second and third output terminals 153a and 154a disposed at the outermost sides of driving chip 150. As a result, a resistance difference of several tens of ohms occurs among internal connection lines 156.

To compensate for this resistance difference among internal connection lines 156, internal connection lines 156 connected to output terminals 152 belonging to a first group in output terminals 152, 153, and 154 are formed of polysilicon. Meanwhile, internal connection lines 156b and 156c connected to output terminals 153 and 154 belonging to second and third groups may be formed of a metal material having a resistance less than that of the polysilicon. The different materials prevent the resistance of respective internal connection lines 156b and 156c positioned at both ends of driving chip 150 from increasing more than that of internal connection lines 156 positioned at a central portion of driving chip 150. In certain embodiments, some internal connection lines 156 connected to output terminals 152 are formed of polysilicon, while other internal connection lines 156 connected to output terminals 152 are formed of a different conductive material having greater resistance than the metal material forming connection lines 156b and 156c.

Further, the widths of internal connection lines 156 may change according to their respective positions. For example, in some embodiments, a width W1 of each of internal connection lines 156 gradually increases with a distance from first internal connection line 156a. A width W2 of each of internal connection lines 156 connected to output terminal 153 gradually increases as the lines approach second internal connection line 156b. A width W3 of each of internal connection lines 156 connected to output terminal 154 gradually increases as the lines draw closer to third internal connection line 156c.

Where only the widths of internal connection lines 156 are adjusted without changing the material of which internal connection lines 156 are formed, a wide space is required to adjust their resistance. However, where a portion of internal connection lines 156 is formed of a polysilicon material having a resistance greater than that of a metal material, and the width of internal connection lines 156 is adjusted also, the wide space is not required to adjust their resistance.

Varying the material of which internal connection lines 156 are formed and adjusting the lines' width prevents the resistance of respective internal connection lines 156b and 156c disposed on both end portions of driving chip 150 from increasing more than that of respective internal connection line 156a disposed at a central portion of driving chip 150. This in turn prevents the delay variation of the data signals from occurring due to a length difference between internal connection lines 156.

Further, the material of which internal connection lines 156 are formed may be changed, and also their width may be adjusted to compensate for the resistance difference occurring by the length difference between first and second external connection lines OCL1 and OCL2. That is, the total resistance of first internal connection line 156a, first film line FL1, and first panel line PL1, which are disposed at the exact center of driving chip 150, may be substantially equal to that of second internal connection line 156b, second film line FL2, and second panel line PL2, which are disposed at the outermost side and that of third internal connection line 156c, third film line FL3, and third panel line PL3, which are disposed at the outermost side.

Thus, although first and second external connection lines OCL1 and OCL2 have lengths different from each other, the data signals are applied to first through m-th data lines DL1 through DLm at substantially the same time point. Image quality is prevented from being deteriorated by signal delay variations of the data signals.

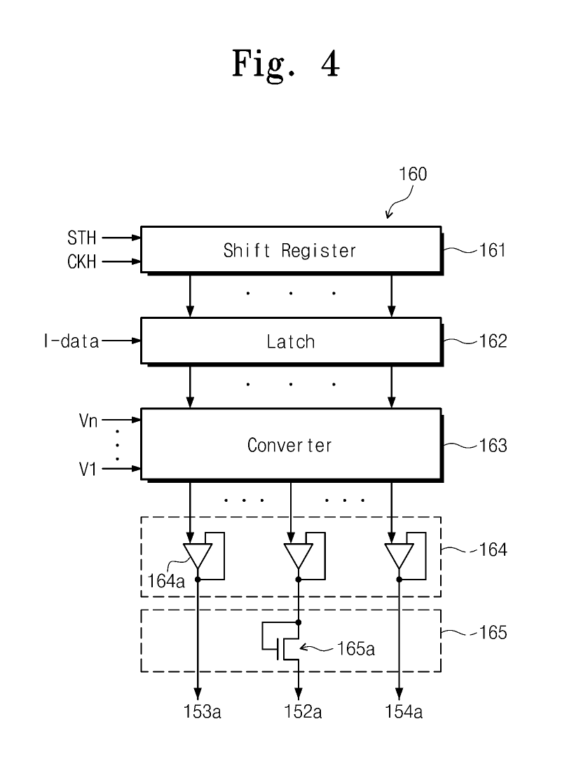

FIG. 4 is a block diagram of a data driver 160 according to an embodiment of the inventive concept.

Referring to FIG. 4, data driver 160 in driving chip 150 of FIG. 1 comprises a shift register 161, a latch 162, a converter 163, and an output buffer 164. Data driver 160 further comprises a resistance controller 165.

Shift register 161 has a plurality of stages connected in cascade. A clock signal CKH and a start signal STH are applied to shift register 161. When a first one of the stages is operated, the stages sequentially output control signals in response to the clock signal CKH.

Latch 162 stores a plurality of data signals I-Data in response to the control signal sequentially supplied from the stages. Latch 162 provides a plurality of stored data signals I-Data to converter 163.

Converter 163 converts data signals I-Data supplied from latch 162 into gray voltages. Specifically, converter 163 receives a plurality of gamma reference voltages V1 through Vn to output gamma reference voltages V1 through Vn corresponding to data signals I-Data as gray voltages.

Output buffer 164 comprises a plurality of operational amplifiers (“op-amps”) 164a. Output buffer 164 receives gray voltages outputted from converter 163 and simultaneously outputs gray voltages. Hereinafter, for convenience of descriptions, gray voltages outputted from output buffer 164 will be referred to as data signals.

Resistance controller 165 is disposed between output buffer 164 and a plurality of output terminals 152, 153, and 154 of driving chip 150. Resistance controller 165 comprises a plurality of active devices having resistances different from each other. In an embodiment of the inventive concept, although the active devices comprise a plurality of transistors 165a, the active devices may comprise a plurality of diodes.

Transistors 165a are disposed between output terminals 152 of a first group of output terminals 152, 153, and 154 and the op-amps corresponding to output terminals 152. Where transistors 165a are connected to output terminals 152 of the first group in which internal connection lines 156 have relatively short lengths, a resistance difference between output terminals 153 and 154 due to a length difference between internal connection lines 156 is reduced.

Further, transistors 165a connected to output terminals 152 have different resistances from each other. That is, transistors 165a decrease in resistance as they move away from first output terminal 152a disposed at the exact center of driving chip 150. Thus, a delay variation between the data signals outputted from output terminals 152, 153, and 154 is reduced.

Resistance controller 165 may be disposed between output buffer 164 and output terminals 152, 153, and 154, and the widths of internal connection lines 156 may be adjusted. That is, internal connection lines 156 connected to output terminals 152 may increase in width as they move away from first internal connection line 156a, and internal connection lines 156 connected to output terminals 153 and 154 may increase in width as they move closer to second and third internal connection lines 156b and 156c.

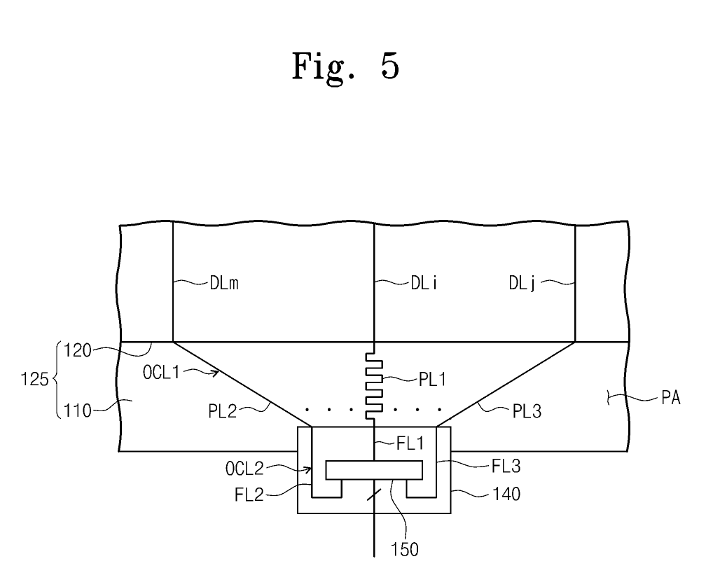

FIG. 5 is an enlarged view of a liquid crystal display panel according to another embodiment of the inventive concept.

Referring to FIG. 5, a plurality of first external connection lines OCL1 is disposed in a liquid crystal display panel 125, and a plurality of second external connection lines OCL2 is disposed on one of TCPs 140. A driving chip 150 is mounted on the one or TCPs 140. Output terminals 152, 153, and 154 (see FIG. 3) of driving chip 150 are electrically connected to corresponding data lines DLj through DLm through first and second external connection lines OCL1 and OCL2.

First external connection lines OCL1 comprise a first panel line PL1, a second panel line PL2, and a third panel line PL3. Second external connection lines OCL2 comprise a first film line FL1, a second film line FL2, and a third film line FL3. First panel line PL1 and first film line FL1 connect a first output terminal 152a (not shown) disposed at the exact center of driving chip 150 to i-th data line DLi of liquid crystal display panel 125. Second panel line PL2 and second film line FL2 connect a second output terminal 153a (not shown) disposed at the outermost side of driving chip 150 to an m-th data line DLm of liquid crystal display panel 125. Also, third panel line PL3 and third film line FL3 connect third output terminal 154a disposed at the outermost side of driving chip 150 to a j-th data line DLj of liquid crystal display panel 125.

As shown in FIG. 5, a straight line distance between first output terminal 152a and i-th data line DLi is relatively short compared to the distance between respective second and third output terminals 153a and 154a and respective m-th and j-th data lines DLm and DLj. To compensate for the distance variation, first panel line PL1 has a curved shape indicated by back and forth lines. Thus, when first panel line PL1 has a curved shape within a given region, a total length of first panel line PL1 becomes longer, thereby reducing a distance difference between first panel line PL1 and second and third panel lines PL2 and PL3. The shapes of panel lines PL2 and PL3, which extend away from the TCP 140, will be referred to as oblique shapes.

For convenience of explanation, only first panel line PL1 has the curved shape in FIG. 5. However, first external connection lines OCL1 corresponding to a first group of output terminals 152, 153, and 154 of driving chip 150 may also have curved shapes to adjust their lengths to approximately the same length.

Thus, when a length of each of first external connection lines OCL1 is adjusted to compensate for a resistance difference between first external connection lines OCL1 and, as shown in FIGS. 3 and 5, internal connection lines 156 of driving chip 150, the delay variation of the data signals is substantially removed. Consequently image quality is prevented from being deteriorated by delay variations in the data signals.

Although not shown, first external connection lines OCL1 typically have widths gradually increasing from first panel line PL1 toward second and third panel lines PL2 and PL3.

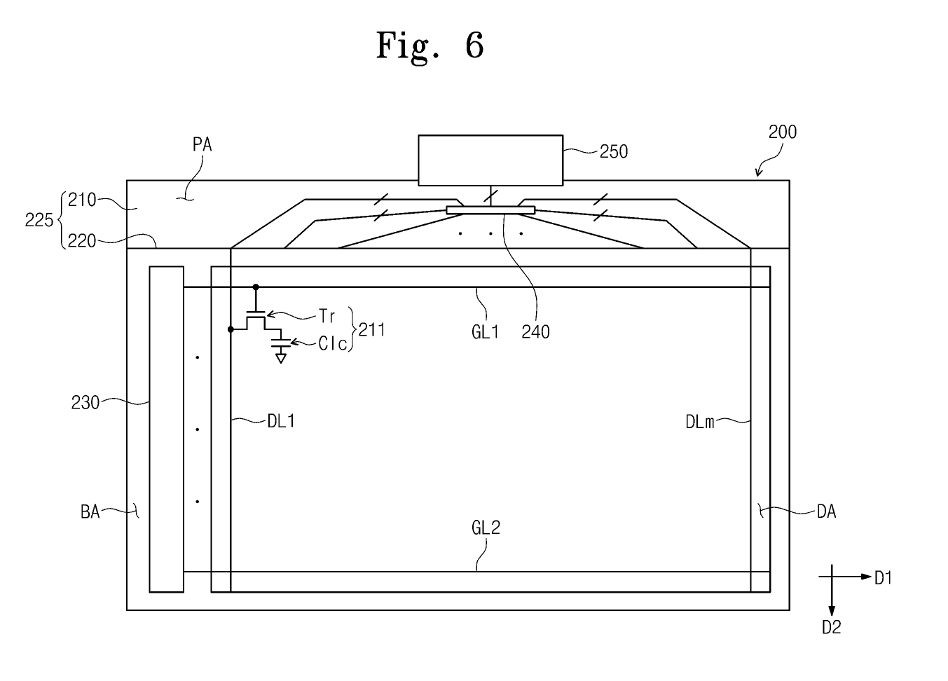

FIG. 6 is a plan view of a liquid crystal display device 200 according to another embodiment of the inventive concept.

Referring to FIG. 6, liquid crystal display device 200 concept comprises a liquid crystal display panel 225, a driving chip 240, and a flexible circuit film 250.

Liquid crystal display panel 225 comprises a lower substrate 210 and an upper substrate 220, coupled to each other. Liquid crystal display panel 225 has a display area DA, a black matrix area BA, and a peripheral area PA. A plurality of gate lines GL1 through GLn, a plurality of data lines DL1 through DLm, and a plurality of pixels 211 are disposed in display area DA. Each of pixels 211 comprise a thin film transistor Tr and a liquid crystal capacitor Clc.

A black matrix is disposed in black matrix area BA. A gate driver 230 is disposed at a side where ends of gate lines GL1 through GLn are disposed. Gate driver 230 is connected to gate lines GL1 through GLn to sequentially supply gate signals.

Driving chip 240 is directly mounted in peripheral area PA of liquid crystal display panel 225. For example, one driving chip 240 is provided and electrically connected to a plurality of data lines DL1 through DLm. A data driver is built in driving chip 240, and output terminals of driving chip 240 output a plurality of data signals.

Where the number of the chips provided in liquid crystal display device 200 increases, the cost and defect rate increase to cause reduction in productivity. As a result, there is a tendency to reduce the number of chips in a liquid crystal display device, with a preference for liquid crystal display device 200 to have one driving chip 240.

In liquid crystal display device 200 comprising one driving chip 240, the output terminals of driving chip 240 are arranged in two rows or disposed along four edges of driving chip 240 in liquid crystal display device 200 because data lines DL1 through DLm are commonly connected to driving chip 240.

Driving chip 240 of liquid crystal display device 200 having the above-described structure may have the same structure as driving chip 150 of FIG. 3. Specifically, because the internal connection lines (see reference numeral 156 of FIG. 3) disposed in driving chip 240 are formed of materials different from each other according to the positions of the lines, or widths of the internal connection lines are adjusted according to the positions, the delay variation of the data signals is improved due to the length difference among internal connection lines 156.

Further, the length difference occurs between external connection lines OCL electrically connecting the output terminals disposed between driving chip 140 and data lines DL1 through DLm in peripheral region PA of liquid crystal display panel 225 to data lines DL1 through DLm. The length difference is adjusted by changing the materials and widths of internal connection lines 156 of driving chip 240. Further, as shown in FIG. 4, a portion of external connection lines OCL has a curved shape to provide uniform resistance of external connection lines OCL. Therefore, the delay variation of the data signals are substantially removed, and thus, the image quality of liquid crystal display device 200 are improved.

In certain embodiments of the inventive concept described above, a image display apparatus comprises a driving chip having groups of output terminals with relatively short internal connection lines for providing driving signals to the display panel, and groups of output terminals with relatively long internal connection lines for providing driving signals to the display panel. The relatively short connection lines are formed of a material having a relatively high resistance, and the relatively long connection lines are formed of a material with a relatively lower resistance. Using these different resistances may improve the image quality of the liquid crystal display device.

The foregoing is illustrative of embodiments and is not to be construed as limiting thereof. Although a few embodiments have been described, those skilled in the art will readily appreciate that many modifications are possible in the embodiments without materially departing from the novel teachings and advantages of the inventive concept. Accordingly, all such modifications are intended to be included within the scope of the inventive concept as defined in the claims. Therefore, it is to be understood that the foregoing is illustrative of various embodiments and is not to be construed as limited to the specific embodiments disclosed, and that modifications to the disclosed embodiments, as well as other embodiments, are intended to be included within the scope of the appended claims.

What is claimed is:

1. An image display apparatus, comprising:
a display panel comprising a plurality of signal lines receiving a driving signal and displaying an image in response to the driving signal;
a driving chip comprising a data driver generating the driving signal, a plurality of output terminals outputting the driving signal supplied from the driver, and a plurality of internal connection lines electrically connecting the driver to the output terminals; and
a plurality of external connection lines electrically connecting the output terminals to the signal lines,
wherein the internal connection lines are divided into two or more groups according to length of the internal connection lines, and the two or more groups are formed of materials of different resistivity.

2. The image display apparatus of claim 1, wherein the internal connection lines are divided into a first group connected to output terminals disposed at a central portion of the driving chip and second and third groups disposed on opposite distal portions of the driving chip,
wherein the first group is formed of a first material, and the second and third groups are formed of a second material having a resistance less than that of the first material.

3. The image display apparatus of claim 2, wherein the first material comprises a polysilicon material, and the second material comprises a metal material.

4. The image display apparatus of claim 2, wherein the driving chip further comprises active devices connected to the internal connection lines of the first group.

5. The image display apparatus of claim 2, wherein the internal connection lines of the first group have widths that gradually increase from a central portion of the driving chip toward the distal portions of the driving chip, and the internal connection lines of the second and third groups have widths that gradually increase toward outermost internal connection lines on the distal portions.

6. The image display apparatus of claim 2, wherein a back surface of the driving chip has a rectangular shape having four outer edges, the output terminals are disposed along at least three of the four outer edges, and a plurality of input terminals receiving signals from the outside is disposed along the remaining outer edge.

7. The image display apparatus of claim 6, wherein the output terminals are partially disposed on the remaining outer edge.

8. The image display apparatus of claim 1, further comprising a film on which the driving chip is mounted.

9. The image display apparatus of claim 8, wherein the external connection lines comprise:
a plurality of first external connection lines disposed on the display panel and connected to the signal lines; and
a second external connection line disposed on the film to connect the output terminals of the driving chip to the first external connection lines of the display panel.

10. The image display apparatus of claim 9, wherein the output terminals are divided into a first group disposed on a central portion of the driving chip and second and third groups respectively disposed on opposite side edges of the driving chip,
wherein the first external connection lines connected to the first group have curved shapes, and the first external connection lines connected to the second and third groups have oblique shapes.

11. The image display apparatus of claim 1, wherein the driving chip is mounted on the display panel.

12. The image display apparatus of claim 11, wherein the external connection lines are disposed on the display panel to electrically connect the output terminals of the driving chip to the signal lines.

13. The image display apparatus of claim 12, wherein the output terminals are divided into a first group disposed on a central portion of the driving chip and second and third groups respectively disposed on both side edges of the driving chip,
wherein the external connection lines connected to the first group have curved shapes, and the external connection lines connected to the second and third groups have oblique shapes.
